(19) United States
(12) Patent Application Publication
(10) Pub. No.: US 2007/0026817 A1
(43) Pub. Date: Feb. 1, 2007

(54) Antenna duplexer

(75) Inventor: Shinichi Kodama, Daito-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/490,258

(22) Filed: Jul. 21, 2006

(30) Foreign Application Priority Data
Jul. 26, 2005 (JP) 2005-216486

(51) Int. Cl. H04B 1/44; H04B 1/04; H04M 1/00

(52) U.S. Cl. 455/78; 455/129; 455/575.7

(57) ABSTRACT

An antenna duplexer of the present invention includes a first transmission/reception circuit for transmitting/receiving a GSM signal, and a second transmission/reception circuit for transmitting/receiving DCS and W-CDMA signals, which are connected in parallel via a diplexer. A third trap circuit including an inductor and a capacitor for forming a series resonant circuit having a resonant frequency in the W-CDMA frequency band is connected to a transmission line of the first transmission/reception circuit between a second diode switch interposed in series therewith and a branch terminal. The inductor is interposed in series between the second diode switch and the branch terminal. The capacitor has one end connected to a connection line between the inductor and the second diode switch, with the other end grounded.

The priority application Number 2005-216486 upon which this patent application is based is hereby incorporated by reference.

### BACKGROUND OF THE INVENTION

1. Field of the Invention

The present invention relates to an antenna duplexer provided in portable telephones or the like.

2. Description of Related Art

There has been conventionally known an antenna duplexer capable of transmitting/receiving dual band signals of DCS (Digital Cellular System) employing a 1800 MHz band used in Europe and GSM (Global System For Mobile Communications) employing a 900 MHz band used in Europe and other places (see JP 2002-246809, A).

FIG. 17 shows a circuit configuration of a conventional dual band type antenna duplexer 6. The antenna duplexer 6 includes a first transmission/reception circuit 7 for transmitting/receiving a GSM signal of a low-frequency band and a second transmission/reception circuit 4 for transmitting/receiving a DCS signal of a high-frequency band, which are connected in parallel via a diplexer 2.

The first transmission/reception circuit 7 includes a switching circuit 71 having two diode switches 77, 78 for switching GSM transmission/reception, and a low-pass filter circuit 72 for cutting off unnecessary higher harmonics from a GSM transmission circuit, and has a reception signal terminal 73 for outputting a reception signal to a GSM reception circuit, a transmission signal terminal 74 for inputting thereto a transmission signal from the GSM transmission circuit, and a control terminal 75 for inputting thereto a signal for on/off controlling the two diode switches 77, 78.

The second transmission/reception circuit 4 includes a switching circuit 41 having two diode switches 47, 48 for switching DCS transmission/reception, and a low-pass filter circuit 42 for cutting off unnecessary higher harmonics from a DCS transmission circuit, and has a reception signal terminal 43 for outputting a reception signal to a DCS reception circuit, a transmission signal terminal 44 for inputting thereto a transmission signal from the DCS transmission circuit, and a control terminal 45 for inputting thereto a signal for on/off controlling the two diode switches 47, 48.

The diplexer 2 has a first trap circuit including an inductor L2 and a capacitor C3, and a second trap circuit including an inductor L1 and a capacitor C2. The first trap circuit is disposed at the first transmission/reception circuit 7 side, while the second trap circuit is disposed at the second transmission/reception circuit 4 side. The first trap circuit has an attenuation pole at a frequency f2 within a DCS transmission/reception band shown in FIG. 19, while the second trap circuit has an attenuation pole at a frequency f1 within a GSM transmission/reception band shown in FIG. 19.

A coupling capacitor C6 for cutting off a direct current voltage for on/off controlling the diode switches 77, 78 is interposed between the first trap circuit and the first transmission/reception circuit 7. A coupling capacitor C5 for cutting off a direct current voltage for on/off controlling the diode switches 47, 48 is interposed between the second trap circuit and the second transmission/reception circuit 4.

A signal received by an antenna is input to an antenna connecting terminal 21 of the diplexer 2. When a DCS reception signal is input to the antenna connecting terminal 21, the first trap circuit prevents the DCS reception signal from passing into the first transmission/reception circuit 7, and causes the DCS reception signal to flow toward the second transmission/reception circuit 4.

In contrast, when a GSM reception signal is input to the antenna connecting terminal 21, the second trap circuit prevents the GSM reception signal from passing into the second transmission/reception circuit 4, and causes the GSM reception signal to flow toward the first transmission/reception circuit 7.

On the other hand, when a GSM transmission signal is input to the transmission signal terminal 74, the transmission signal is input through the first transmission/reception circuit 7 to the diplexer 2. The GSM transmission signal is prevented by the second trap circuit from passing into the second transmission/reception circuit 4, and output through the antenna connecting terminal 21 from the antenna.

When a DCS transmission signal is input to the transmission signal terminal 44, the transmission signal is input through the second transmission/reception circuit 4 to the diplexer 2. The DCS transmission signal is prevented by the first trap circuit from passing into the first transmission/reception circuit 7, and output through the antenna connecting terminal 21 from the antenna. As described above, the diplexer 2 can separate the GSM and DCS transmission/reception signals.

FIG. 18 shows a configuration of the first transmission/reception circuit 7 of the antenna duplexer 6, with the low-pass filter circuit 72 not shown. A second diode switch 78 is interposed in series with a transmission line 70b from the transmission signal terminal 74 to a low-frequency circuit terminal F of the diplexer 2.

On the other hand, a microstripline 76 with a length corresponding to one-fourth wavelength of the GSM transmission signal is interposed on a reception line 70a from the terminal F to the reception signal terminal 73. A first diode switch 77 has one end thereof connected to a connection line between the microstripline 76 and the reception signal terminal 73, with the other end grounded.

Both diode switches 77, 78 are off during GSM reception, or during DCS transmission/reception. The transmission line 70b is then open, and therefore the GSM reception signal flows through the reception line 70a. The microstripline 76 simply functions as a connection line when the first diode switch 77 is off, and therefore the GSM reception signal passes through the microstripline 76 and is output from the reception signal terminal 73.

On the other hand, both diode switches 77, 78 are on during GSM transmission. When the diode switch 77 is on, one end of the microstripline 76 is grounded, which causes the microstripline 76 to perform a function of preventing the GSM transmission signal from passing into the reception line 70a. Consequently, the GSM transmission signal input to the transmission signal terminal 74 is input through the terminal F to the diplexer 2, and output via the diplexer 2 from the antenna connecting terminal 21.

The second transmission/reception circuit 4 will not be described because, as shown in FIG. 17, it has the same configuration as of the first transmission/reception circuit 7, except for use of a microstripline 46 with a length corresponding to one-fourth wavelength of the DCS transmission signal instead of the microstripline 76.

FIG. 19 shows signal pass characteristics of the first transmission/reception circuit 7 and the second transmission/reception circuit 4. In FIG. 19, signal pass characteristics of the second transmission/reception circuit 4 is shown by a solid line, and signal pass characteristics of the first transmission/reception circuit 7 is shown by a broken line. As seen, the first transmission/reception circuit 7 for GSM transmission/reception gives little signal loss in the GSM transmission/reception band, but sufficiently attenuates signals in the DCS transmission/reception band. In contrast, it can be seen that the second transmission/reception circuit 4 for DCS transmission/reception gives little signal loss in the DCS transmission/reception band, but sufficiently attenuates signals in the GSM transmission/reception band. This allows transmission/reception of dual band signals of DCS and GSM.

In recent years, there have been proposed for portable telephones new communications standards such as PCS (Personal Communication Services) employing a 1900 MHz band and W-CDMA (Wideband Code Division Multiple Access) employing a 1900-2170 MHz band. This has been demanding development of triple band type or quad band type antenna duplexers adapted for these new communications standards in addition to for conventional DCS and GSM.

FIG. 20 shows a circuit configuration of a triple band type antenna duplexer 6a applicable to DCS, GSM and W-CDMA (see JP 2003-209454, A). The antenna duplexer 6a has the same configuration as of the dual band type antenna duplexer 6 shown in FIG. 18, except that it has a diplexer of a different configuration.

Like the diplexer 2 of the antenna duplexer 6 shown in FIG. 18, a diplexer 2a of the antenna duplexer 6a has a first trap circuit having an attenuation pole at a frequency f2 within a DCS transmission/reception band shown in FIG. 21, and a second trap circuit having an attenuation pole at a frequency f1 within a GSM transmission/reception band shown in FIG. 21.

The diplexer 2a includes a third trap circuit 29 including an inductor L51 and a capacitor C51 connected in series. The third trap circuit 29 has one end thereof connected to a connection line between the coupling capacitor C6 at the first transmission/reception circuit 7 side and the first trap circuit, with the other end grounded. The third trap circuit 29 has a resonant frequency at a frequency f3 within a W-CDMA transmission/reception band shown in FIG. 21. The third trap circuit 29 prevents W-CDMA transmission/reception signals from passing into the first transmission/reception circuit 7.

Therefore, during GSM reception, or during DCS and W-CDMA transmission/reception, the second trap circuit prevents signals having a frequency in the DCS transmission/reception band from passing into the first transmission/reception circuit 7, while the third trap circuit 29 prevents signals having a frequency in the W-CDMA transmission/reception band from passing into the first transmission/reception circuit 7.

As shown in FIG. 21, according to the above triple band type antenna duplexer 6a, signals of a band corresponding to frequencies of DCS and W-CDMA transmission/reception signals can be sufficiently attenuated over a wide band during GSM reception. In addition, DCS and W-CDMA transmission/reception signals are prevented from flowing into the first transmission/reception circuit 7 during DCS or W-CDMA reception. Therefore, good transmission/reception performance can be achieved without attenuating the DCS and W-CDMA transmission/reception signals.

Generally, as shown in FIG. 22, the above dual band type antenna duplexer 6 and triple band type antenna duplexer 6a are modularized using an LTCC (Low Temperature Co-fired Ceramics) substrate. The diplexer, which is one component of these antenna duplexers, includes inductors and capacitors, and therefore, in many cases, is formed on inner layers of the LTCC substrate. Therefore, a need for design change in the diplexer could lead to design change of the LTCC substrate itself.

Thus, the above conventional antenna duplexer 6a needs design change of the LTCC substrate itself, as it is adapted for triple bands or quad bands by adding the third trap circuit 29 in the diplexer 2 of the dual band type antenna duplexer 6. This has caused a problem of the design and development requiring a long time.

Furthermore, because the third trap circuit 29 is disposed in the diplexer 2a, GSM transmission/reception signals pass through the third trap circuit 29 during GSM transmission/reception. The third trap circuit 29 can, though slightly, block passage of signals having a frequency outside the W-CDMA transmission/reception band. This has caused a problem of GSM transmission/reception signal loss.

### SUMMARY OF THE INVENTION

An object of the present invention is to provide an antenna duplexer where signal loss due to addition of a new trap circuit can be reduced, and moreover, which allows a shortened design and development time.

An antenna duplexer of the present invention is for transmitting/receiving radio waves of a plurality of different frequency bands, and includes a first trap circuit for blocking passage of a signal of a first frequency band, disposed between a first terminal 24 and an antenna connecting terminal 21; a second trap circuit for blocking passage of a signal of a second frequency band different from the first frequency band, disposed between a second terminal 23 and the antenna connecting terminal 21; a second transmission/reception circuit 4 connected to the first terminal 24, for transmitting/receiving signals of the second frequency band and a third frequency band adjacent thereto; and a first transmission/reception circuit 3 connected to the second terminal 23, for transmitting/receiving a signal of the first frequency band.

The first transmission/reception circuit 3 has a reception line 30a for passing therethrough a reception signal of the first frequency band, and a transmission line 30b for passing therethrough a transmission signal of the first frequency band. The reception line 30a has a microstripline 36 with a length corresponding to one-fourth wavelength of the transmission signal of the first frequency band, interposed in series therewith, and a first diode switch 37 having one end thereof connected to a connection line from the microstripline 36 to a reception signal terminal 33 at a terminal end of the reception line 30a, with the other end grounded.

The transmission line 30b has a second diode switch 38 interposed in series therewith, and a third trap circuit 5a for blocking passage of a signal of the third frequency band, interposed between the second diode switch 38 and the second terminal 23. The third trap circuit 5a includes an inductor and a capacitor. Any one passive device of the inductor and the capacitor is interposed between the second diode switch 38 and the second terminal 23. The other passive device has one end thereof connected to a connection line between the one passive device and the second diode switch 38, with the other end grounded.

Specifically, the antenna duplexer of the present invention is modularized using a laminated substrate, and the third trap circuit is provided on a surface of the laminated substrate, together with the first diode switch 37 and the second diode switch 38.

In the above antenna duplexer of the present invention, the first and second diode switches 37, 38 are off during reception of the signal of the first frequency band, or during transmission/reception of the signals of the second and third frequency bands. When the second diode switch 38 is off, and the transmission line 30b is open, the inductor and capacitor of the third trap circuit 5a are connected in series, so that the inductor and capacitor form a series resonant circuit having one end connected to the reception line 30a with the other end grounded. The series resonant circuit performs a function of preventing the signal of the third frequency band from passing into the reception line 30a. Consequently, the signals of the second and third frequency bands can be sufficiently attenuated during reception of the signal of the first frequency band, and the signals of the second and third frequency bands are prevented from flowing into the first transmission/reception circuit 3 during transmission/reception of the signals of the second and third frequency bands.

On the other hand, the first and second diode switches 37, 38 are on during transmission of the signal of the first frequency band. The series resonant circuit is lost by the second diode switch 38 turned on. Therefore, during transmission of the signal of the first frequency band, the transmission signal loss can be reduced.

With a low temperature co-fired ceramics laminated substrate having an antenna duplexer modularized thereon, a diode switch is mounted generally on a surface of the low temperature co-fired ceramics laminated substrate. Because the third trap circuit 5a is connected to one end of the second diode switch 38, triple band capability can be achieved, for example, by only adding the third trap circuit 5a including chip parts on a surface of a low temperature co-fired ceramics laminated substrate having the conventional dual type antenna duplexer modularized thereon. Thus, the triple band capability can be achieved by only design change of a ceramic layer constituting a surface layer of the low temperature co-fired ceramics laminated substrate. Consequently, design and development time for the antenna duplexer can be shortened more than conventionally.

In another specific configuration, the transmission line 30b has a second diode switch 38 interposed in series therewith, while the reception line 30a has a microstripline 36 with a length corresponding to one-fourth wavelength of the transmission signal of the first frequency band, interposed in series therewith; a third trap circuit 5b for blocking passage of a signal of the third frequency band, interposed between the microstripline 36 and a reception signal terminal 33 at a terminal end of the reception line 30a, the third trap circuit 5b including an inductor and a capacitor connected in parallel with each other; and a first diode switch 37 having one end thereof connected to a connection line between the third trap circuit 5b and the microstripline 36, with the other end grounded.

According to the specific configuration, the first and second diode switches 37, 38 are off during reception of the signal of the first frequency band, or during transmission/reception of the signals of the second and third frequency bands. The transmission line 30b is caused to be open by the second diode switch 38 turned off, so that the signals pass through the reception line 30a.

The third trap circuit 5b includes a parallel resonant circuit including the inductor and the capacitor. The third trap circuit 5b is interposed in series with the reception line 30a, and therefore performs a function of blocking passage of the signal of the third frequency band. Accordingly, the signals of the second and third frequency bands can be sufficiently attenuated during reception of the signal of the first frequency band, and the signals of the second and third frequency bands are prevented from flowing into the first transmission/reception circuit 3 during transmission/reception of the signals of the second and third frequency bands.

On the other hand, the first and second diode switches 37, 38 are on during transmission of the signal of the first frequency band. One end of the microstripline 36 interposed in series with the reception line 30a is grounded by the first diode switch 37 turned on. This causes the microstripline 36 to perform a function of blocking passage of the transmission signal of the first frequency band. Consequently, the transmission signal is prevented from flowing into the reception line 30a from the transmission line 30b. Therefore, during transmission of the signal of the second frequency band, the transmission signal hardly passes through the third trap circuit 5b. Thus, the transmission signal loss can be reduced.

Because the third trap circuit 5b is connected to one end of the first diode switch 37, triple band capability can be achieved, for example, by only adding the third trap circuit 5b including chip parts on a surface of a low temperature co-fired ceramics laminated substrate having the conventional dual type antenna duplexer modularized thereon.

In another specific configuration, the transmission line 30b has a second diode switch 38 interposed in series therewith, while the reception line 30a has a microstripline 36 with a length corresponding to one-fourth wavelength of the transmission signal of the first frequency band, interposed in series therewith; a third trap circuit 5c for blocking passage of a signal of the third frequency band, connected to a connection line from the microstripline 36 to a reception signal terminal 33 at a terminal end of the reception line 30a, the third trap circuit 5c including an inductor and a capacitor connected in series with each other, the third trap circuit 5c having one end thereof connected to the connection line from the microstripline 36 to the reception signal terminal 33 at the terminal end of the reception line 30a, with the other end grounded; and a first diode switch 37 having one end thereof connected to a connection line between the third trap circuit 5c and the microstripline 36, with the other end grounded.

According to the specific configuration, the first and second diode switches 37, 38 are off during reception of the signal of the first frequency band, or during transmission/reception of the signals of the second and third frequency bands. The transmission line 30b is caused to be open by the second diode switch 38 turned off, so that the signals pass through the reception line 30a.

The third trap circuit 5c includes a series resonant circuit including the inductor and the capacitor. Because the third trap circuit 5c has one end thereof connected to the reception line 30a with the other end grounded, the third trap circuit 5c performs a function of blocking passage of the signal of the third frequency band. Accordingly, the signals of the second and third frequency bands can be sufficiently attenuated during reception of the signal of the first frequency band, and the signals of the second and third frequency bands are prevented from flowing into the first transmission/reception circuit 3 during transmission/reception of the signals of the second and third frequency bands.

On the other hand, the first and second diode switches 37, 38 are on during transmission of the signal of the first frequency band. One end of the microstripline 36 interposed in series with the reception line 30a is grounded by the first diode switch 37 turned on. This causes the microstripline 36 to perform a function of blocking passage of the transmission signal of the first frequency band. Consequently, the transmission signal is prevented from flowing into the reception line 30a from the transmission line 30b. Therefore, during transmission of the signal of the second frequency band, the transmission signal hardly passes through the third trap circuit 5c. Thus, the transmission signal loss can be reduced.

Because the third trap circuit 5c is connected to one end of the first diode switch 37, triple band capability can be achieved, for example, by only adding the third trap circuit 5c including chip parts on a surface of a low temperature co-fired ceramics laminated substrate having the conventional dual type antenna duplexer modularized thereon.

In still another specific configuration, the reception line 30a has a microstripline 36 with a length corresponding to one-fourth wavelength of the transmission signal of the first frequency band, interposed in series therewith, and a first diode switch 37 having one end thereof connected to a connection line from the microstripline 36 to a reception signal terminal 33 at a terminal end of the reception line 30a, with the other end grounded. The transmission line 30b has a second diode switch 38 interposed in series therewith, and a microstripline 51 with a length corresponding to one-fourth wavelength of a signal of the third frequency band, interposed between the second diode switch 38 and the second terminal 23. The microstripline 51 constitutes a third trap circuit 5d for blocking passage of the signal of the third frequency band.

According to the specific configuration, the first hand second diode switches 37, 38 are off during reception of the signal of the first frequency band, or during transmission/reception of the signals of the second and third frequency bands. The second diode switch 38 turned off causes the transmission line 30b to be open, and one end of the microstripline 51 to be open. This causes the microstripline 51 to perform a function of preventing the signal of the third frequency band from passing into the reception line 30a. Consequently, the signals of the second and third frequency bands can be sufficiently attenuated during reception of the signal of the first frequency band, and the signals of the second and third frequency bands are prevented from flowing into the first transmission/reception circuit 3 during transmission/reception of the signals of the second and third frequency bands.

On the other hand, the first and second diode switches 37, 38 are on during transmission of the signal of the first frequency band. The microstripline 51 is connected in series with the transmission line 30b by the second diode switch 38 turned on, and simply functions as a connection line. Therefore, the transmission signal loss during transmission of the signal of the first frequency band is reduced.

Because the third trap circuit 5d is connected to one end of the first diode switch 37, triple band capability can be achieved, for example, by only adding the microstripline 51 on a surface of a low temperature co-fired ceramics laminated substrate having the conventional dual type antenna duplexer modularized thereon.

As described above, according to the antenna duplexer of the present invention, signal loss due to addition of a new trap circuit can be reduced, and moreover, design and development time for the antenna duplexer can be shortened because triple band capability can be achieved by only adding the trap circuit on a surface layer of the laminated substrate.

### BRIEF DESCRIPTION OF THE DRAWINGS

FIG. 1 is a circuit diagram showing a configuration of an antenna duplexer of a first embodiment of the present invention;

FIG. 2 is a fragmentary circuit diagram of the antenna duplexer;

FIG. 3 is an equivalent circuit diagram showing a first transmission/reception circuit during reception of a GSM signal, or during transmission/reception of DCS and W-CDMA signals;

FIG. 4 is an equivalent circuit diagram showing the first transmission/reception circuit during transmission of a GSM signal;

FIG. 5 is a fragmentary circuit diagram of an antenna duplexer of a second embodiment of the present invention;

FIG. 6 is an equivalent circuit diagram showing a first transmission/reception circuit during reception of a GSM signal, or during transmission/reception of DCS and W-CDMA signals;

FIG. 7 is an equivalent circuit diagram showing the first transmission/reception circuit during transmission of a GSM signal;

FIG. 8 is a circuit diagram showing a fragmentary configuration of an antenna duplexer of a third embodiment of the present invention;

FIG. 9 is an equivalent circuit diagram showing a first transmission/reception circuit during reception of a GSM signal, or during transmission/reception of DCS and W-CDMA signals;

FIG. 10 is an equivalent circuit diagram showing the first transmission/reception circuit during transmission of a GSM signal;

FIG. 11 is a circuit diagram showing a fragmentary configuration of an antenna duplexer of a fourth embodiment of the present invention;

FIG. 12 is an equivalent circuit diagram showing a first transmission/reception circuit during reception of a GSM signal, or during transmission/reception of DCS and W-CDMA signals;

FIG. 13 is an equivalent circuit diagram showing the first transmission/reception circuit during transmission of a GSM signal;

FIG. 14 is a graph showing a simulation result of signal pass characteristics of the antenna duplexer of the first embodiment of the present invention and signal pass characteristics of a conventional dual band type antenna duplexer;

FIG. 15 is a graph enlargingly showing a range of 0 db to −3 db of the ordinate of FIG. 14;

FIG. 16 is a perspective view showing the antenna duplexer of the first embodiment modularized using an LTCC substrate;

FIG. 17 is a circuit diagram showing a configuration of a conventional dual band type antenna duplexer;

FIG. 18 is a circuit diagram showing a fragmentary configuration of the antenna duplexer;

FIG. 19 is a graph showing signal pass characteristics of the antenna duplexer;

FIG. 20 is a circuit diagram showing a fragmentary configuration of a conventional triple band type antenna duplexer;

FIG. 21 is a graph showing signal pass characteristics of the antenna duplexer; and

FIG. 22 is a perspective view showing the conventional antenna duplexer modularized using an LTCC substrate.

### DETAILED DESCRIPTION OF THE INVENTION

Embodiments of the present invention will be specifically described below with reference to the drawings.

### First Embodiment

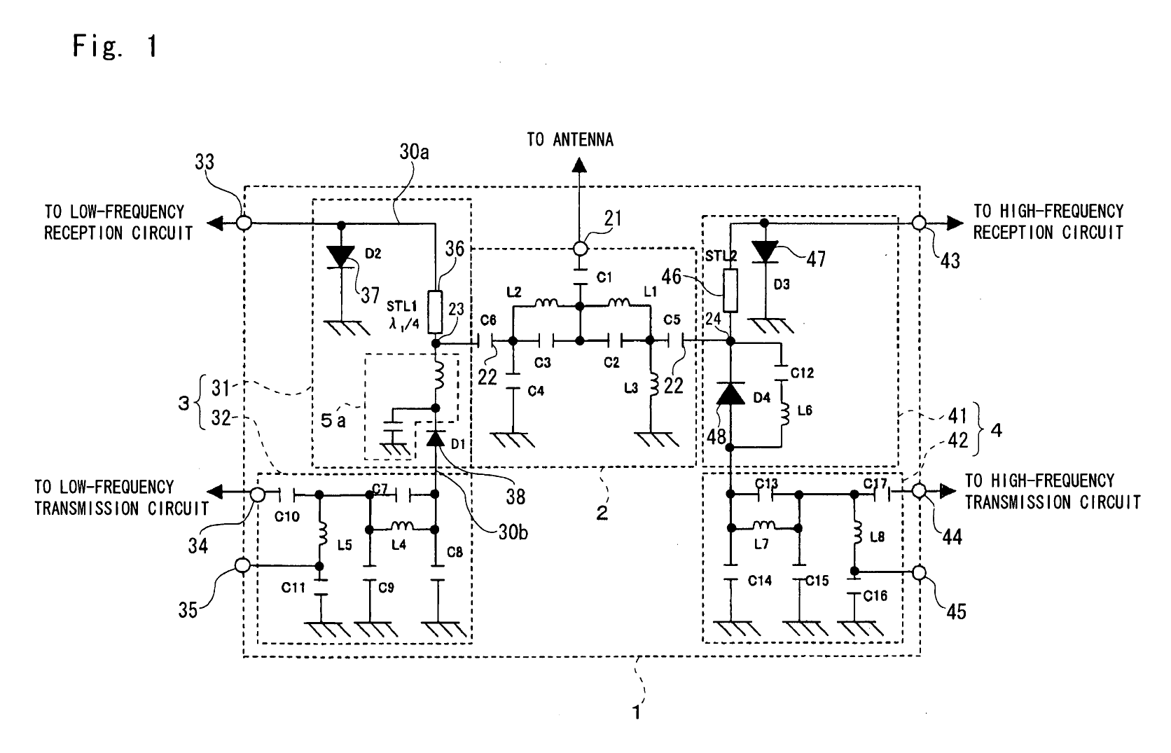

An antenna duplexer 1 of the present embodiment is modularized using an LTCC substrate, and includes, as shown in FIG. 1, a first transmission/reception circuit 3 for transmitting/receiving a GSM signal of a low-frequency band and a second transmission/reception circuit 4 for transmitting/receiving DCS and W-CDMA signals of high-frequency bands, which are connected in parallel via a diplexer 2.

The first transmission/reception circuit 3 includes a switching circuit 31 having two diode switches 37, 38 for switching GSM transmission/reception, and a low-pass filter circuit 32 for cutting off unnecessary higher harmonics from a GSM transmission circuit, and has a reception signal terminal 33 for outputting a reception signal to a GSM reception circuit, a transmission signal terminal 34 for inputting thereto a transmission signal from the GSM transmission circuit, and a control terminal 35 for inputting thereto a signal for on/off controlling the two diode switches 37, 38.

The second transmission/reception circuit 4 includes a switching circuit 41 having two diode switches 47, 48 for switching transmission/reception of DCS and W-CDMA signals, and a low-pass filter circuit 42 for cutting off unnecessary higher harmonics from a DCS and W-CDMA signal transmission circuit, and has a reception signal terminal 43 for outputting a reception signal to a DCS and W-CDMA signal reception circuit, a transmission signal terminal 44 for inputting thereto a transmission signal from the transmission circuit, and a control terminal 45 for inputting thereto a signal for on/off controlling the two diode switches 47, 48.

The diplexer 2 has a first trap circuit including an inductor L2 and a capacitor C3, and a second trap circuit including an inductor L1 and a capacitor C2. The first trap circuit is disposed at the first transmission/reception circuit 3 side, while the second trap circuit is disposed at the second transmission/reception circuit 4 side. The first trap circuit has an attenuation pole at a frequency f2 within a DCS transmission/reception band, while the second trap circuit has an attenuation pole at a frequency f1 within a GSM transmission/reception band.

A coupling capacitor C6 for cutting off a direct current voltage for on/off controlling the diode switches 37, 38 is interposed in series between the first trap circuit and the first transmission/reception circuit 3. A coupling capacitor C5 for cutting off a direct current voltage for on/off controlling diode switches 47, 48 is interposed in series between the second trap circuit and the second transmission/reception circuit 4.

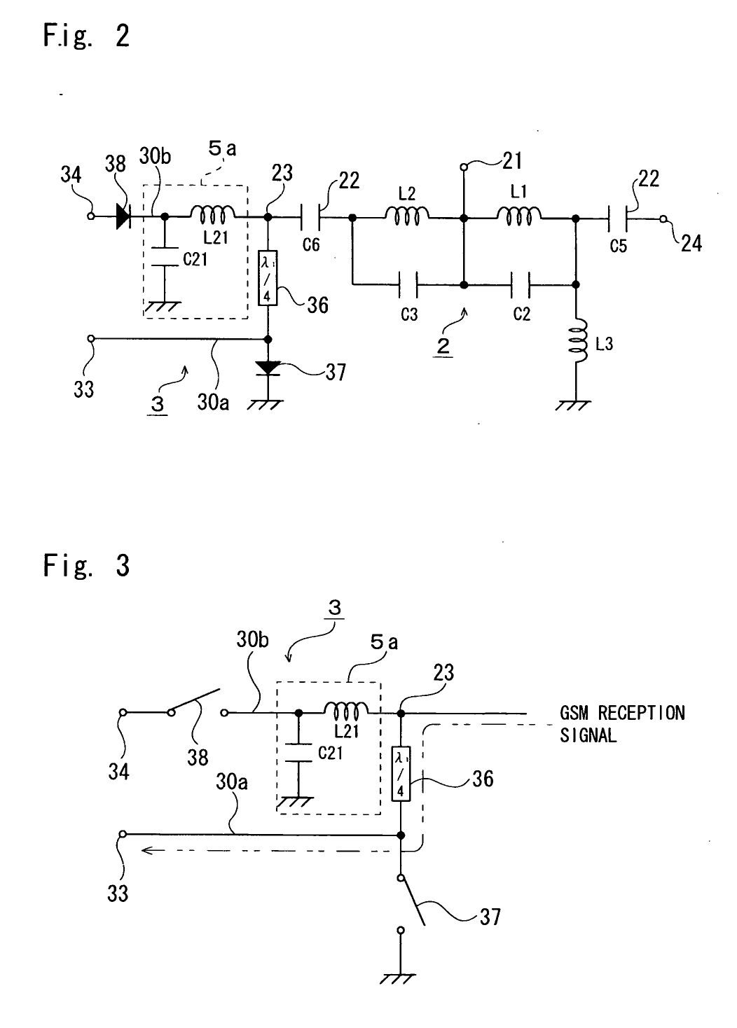

FIG. 2 shows a configuration of the first transmission/reception circuit 3 of the present embodiment, with the low-pass filter circuit 32 not shown. The first transmission/reception circuit 3 has a transmission line 30b from the transmission signal terminal 34 to a low-frequency circuit terminal 23 (hereafter referred to as the branch terminal) of the coupling capacitor C6, and a reception line 30a from the branch terminal 23 to the reception signal terminal 33.

A second diode switch 38 is interposed in series with the transmission line 30b, while a third trap circuit 5a is interposed between the second diode switch 38 and the branch terminal 23. The third trap circuit 5a includes an inductor L21 interposed in series between the second diode switch 38 and the branch terminal 23, and a capacitor C21 having one end thereof connected to a connection line between the inductor L21 and the second diode switch 38 with the other end grounded.

A microstripline 36 with a length corresponding to one-fourth wavelength of GSM transmission signals is interposed in series with the reception line 30a. A first diode switch 37 has one end thereof connected to a connection line between the microstripline 36 and the reception signal terminal 33, with the other end grounded.

The second transmission/reception circuit 4 shown in FIG. 1 will not be described because it has the same configuration as of the first transmission/reception circuit 3, except for use of a microstripline 46 with a length corresponding to one-fourth wavelength of DCS and W-CDMA transmission/reception signals, and for omission of the third trap circuit 5a on the transmission line.

FIG. 3 shows an equivalent circuit of the first transmission/reception circuit 3 during GSM reception. Signals input from an antenna connecting terminal 21 shown in FIG. 2 reach via the first trap circuit in the diplexer 2 to the branch terminal 23. The first trap circuit blocks passage of signals having a frequency in the DCS transmission/reception band, and therefore signals having a frequency outside the DCS transmission/reception band are input to the branch terminal 23.

During GSM reception, as shown in FIG. 3, the first and second diode switches 37, 38 are set off, so that the transmission line 30b is open. The third trap circuit 5a then forms a series resonant circuit having a resonant frequency f3 within the W-CDMA transmission/reception band, with one end thereof grounded, and therefore performs a function of preventing signals having a frequency in the W-CDMA transmission/reception band from passing into the reception line 30a. Thus, during GSM reception, the first trap circuit and the third trap circuit prevent the DCS and W-CDMA signals of high-frequency bands from flowing into the reception line 30a. The microstripline 36 is interposed in series with the reception line 30a, and therefore simply functions as a connection line. Consequently, signals having a frequency in the GSM transmission/reception band are output from the reception signal terminal 33.

The first and second diode switches 37, 38 of the first transmission/reception circuit 3 are set off also during DCS and W-CDMA transmission/reception. In this case, signals having a frequency in the DCS transmission/reception band are blocked by the first trap circuit of the diplexer 2 shown in FIG. 2, while signals having a frequency in the W-CDMA transmission/reception band are blocked by the third trap circuit 5a shown in FIGS. 2 and 3. Consequently, DCS and W-CDMA signals of high-frequency bands are prevented from flowing into the first transmission/reception circuit 3.

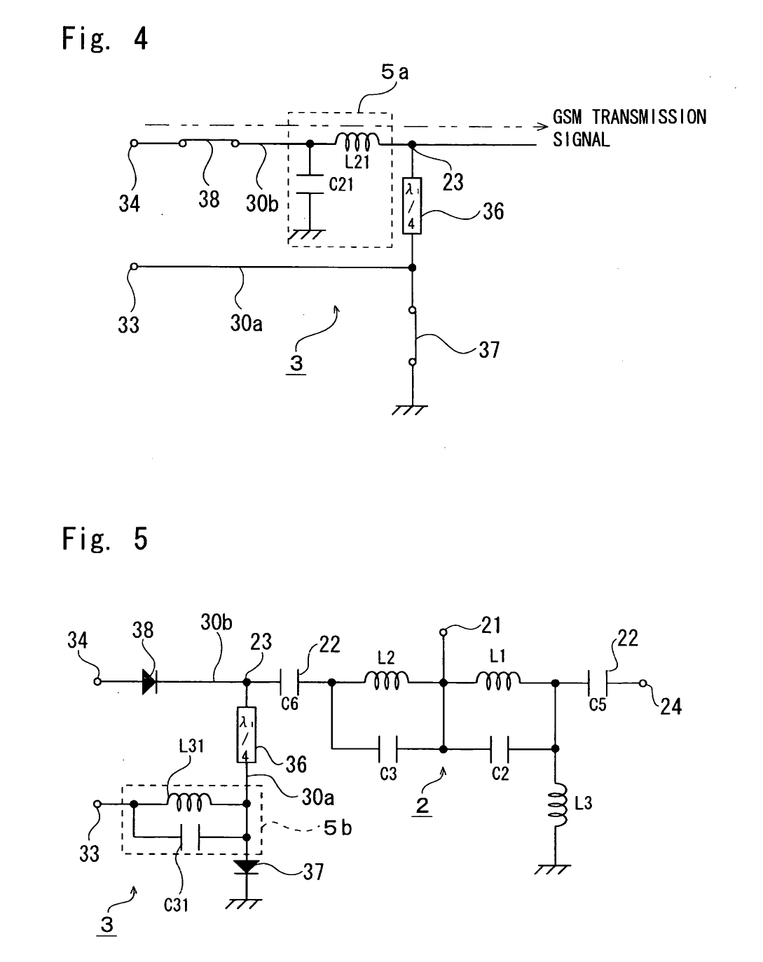

On the other hand, FIG. 4 shows an equivalent circuit of the first transmission/reception circuit 3 during GSM transmission. The first and second diode switches 37, 38 are set on during GSM transmission. The second diode switch 38 set on causes the inductor L21 for forming the series resonant circuit to be connected in series with the transmission line 30b, and the capacitor C21 to have one end thereof connected to the transmission line 30b with the other end grounded. Consequently, the function as a series resonant circuit is lost. Therefore, the third trap circuit 5a fails to function as a trap circuit during GSM transmission, so that the GSM transmission signal loss can be reduced.

The first diode switch 37 set on causes the microstripline 36 interposed in series with the reception line 30a to have one end thereof grounded. This causes the microstripline 36 to perform a function of blocking passage of signals of the GSM frequency band. Consequently, GSM transmission signals are prevented from flowing into the reception line 30a from the transmission line 30b.

### Second Embodiment

The present embodiment is the same as the above first embodiment except that the third trap circuit has a different configuration and connected position. Therefore, only the third trap circuit will be described, and the configuration of other circuits will not be described.

FIG. 5 shows a configuration of the first transmission/reception circuit 3 of the present embodiment, with the low-pass filter circuit 32 shown in FIG. 1 not shown. The microstripline 36 with a length corresponding to one-fourth wavelength of GSM transmission/reception signals is interposed in series with the reception line 30a. The first diode switch 37 has one end thereof connected to a connection line between the microstripline 36 and the reception signal terminal 33, with the other end grounded. A third trap circuit 5b is interposed in series between the microstripline 36 and the reception signal terminal 33. The third trap circuit 5b includes a parallel resonant circuit including an inductor L31 and a capacitor C31, and has an attenuation pole at a frequency f3 in the W-CDMA transmission/reception band. On the other hand, the second diode switch 38 is interposed in series with the transmission line 30b.

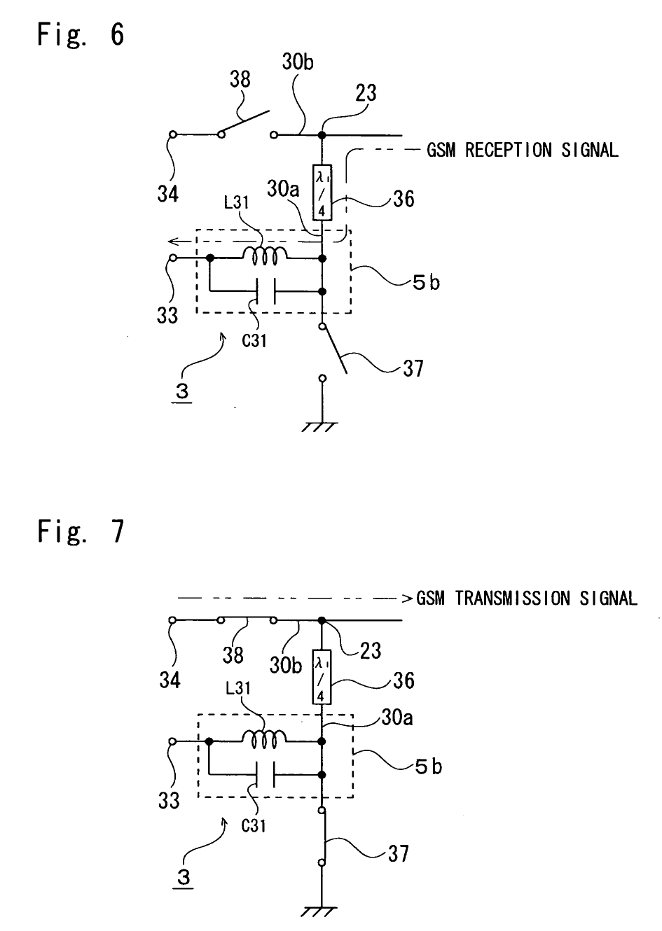

FIG. 6 shows an equivalent circuit of the first transmission/reception circuit 3 of the present embodiment during GSM reception. Signals input from the antenna connecting terminal 21 shown in FIG. 5 reach via the first trap circuit in the diplexer 2 to the branch terminal 23. The first trap circuit blocks passage of signals having a frequency in the DCS transmission/reception band, and therefore signals having a frequency outside the DCS transmission/reception band are input to the branch terminal 23.

During GSM reception, as shown in FIG. 6, the first and second diode switches 37, 38 are set off, so that the transmission line 30b is open. Therefore, the signals are prevented from flowing into the transmission line 30b. The microstripline 36 is interposed in series with the reception line 30a, and therefore simply functions as a connection line. When the signals reach the third trap circuit 5b, the third trap circuit 5b blocks passage of signals having a frequency in the W-CDMA transmission/reception band. Consequently, signals having a frequency in the GSM transmission/reception band are output from the reception signal terminal 33.

The first and second diode switches 37, 38 of the first transmission/reception circuit 3 are set off also during DCS and W-CDMA transmission/reception. In this case, signals having a frequency in the DCS transmission/reception band are blocked by the first trap circuit of the diplexer 2 shown in FIG. 5, while signals having a frequency in the W-CDMA transmission/reception band are blocked by the third trap circuit 5b. This prevents the DCS and W-CDMA signals of high-frequency bands from flowing into the first transmission/reception circuit 3.

On the other hand, FIG. 7 shows an equivalent circuit of the first transmission/reception circuit 3 of the present embodiment during GSM transmission. The first and second diode switches 37, 38 are set on during GSM transmission. The first diode switch 37 set on causes the microstripline 36 interposed in series with the reception line 30a to have one end thereof grounded. This causes the microstripline 36 to perform a function of blocking passage of signals of the GSM frequency band. Consequently, GSM transmission signals are prevented from flowing into the reception line 30a from the transmission line 30b.

Therefore, signals of the GSM frequency band hardly pass through the third trap circuit 5b during GSM transmission. Consequently, the GSM transmission signal loss is reduced.

### Third Embodiment

The present embodiment is the same as the above second embodiment except that the third trap circuit has a different configuration. Therefore, only the third trap circuit will be described, and the configuration of other circuits will not be described.

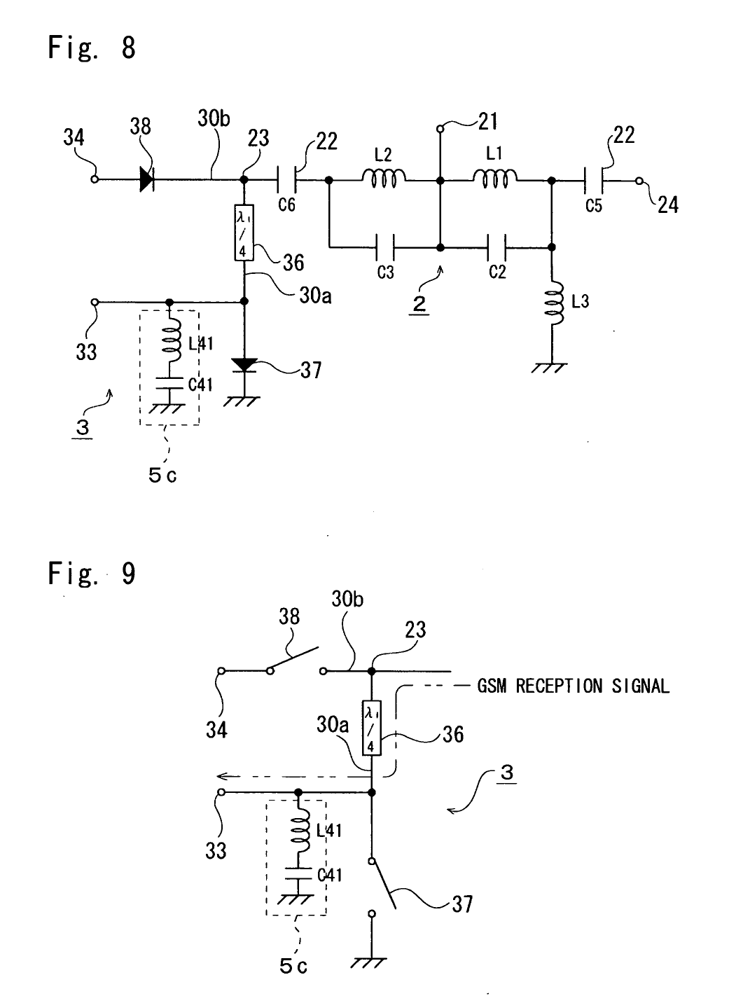

FIG. 8 shows a configuration of the first transmission/reception circuit 3 of the present embodiment, with the low-pass filter circuit 32 shown in FIG. 1 not shown. The microstripline 36 with a length corresponding to one-fourth wavelength of GSM transmission/reception signals is interposed in series with the reception line 30a. The first diode switch 37 has one end thereof connected to a connection line between the microstripline 36 and the reception signal terminal 33, with the other end grounded. A third trap circuit 5c has one end thereof connected to a connection line between the microstripline 36 and the reception signal terminal 33, with the other end grounded. The third trap circuit 5c includes a series resonant circuit including an inductor L41 and a capacitor C41, and has a resonant frequency at a frequency f3 in the W-CDMA transmission/reception band. On the other hand, the second diode switch 38 is interposed on the transmission line 30b.

FIG. 9 shows an equivalent circuit of the first transmission/reception circuit 3 of the present embodiment during GSM reception. Signals input from the antenna connecting terminal 21 shown in FIG. 8 reach via the first trap circuit in the diplexer 2 to the branch terminal 23. The first trap circuit blocks passage of signals having a frequency in the DCS transmission/reception band, and therefore signals having a frequency outside the DCS transmission/reception band are input to the branch terminal 23.

During GSM reception, as shown in FIG. 9, the first and second diode switches 37, 38 are set off, so that the transmission line 30b is open. Therefore, the signals are prevented from flowing into the transmission line 30b. The microstripline 36 is interposed in series with the reception line 30a, and therefore simply functions as a connection line. When the signals reach through the microstripline 36 to the third trap circuit 5c, the third trap circuit 5c blocks passage of signals having a frequency in the W-CDMA transmission/reception band. Consequently, signals having a frequency in the GSM transmission/reception band are output from the reception signal terminal 33.

The first and second diode switches 37, 38 of the first transmission/reception circuit 3 are set off also during DCS and W-CDMA transmission/reception. In this case, the first trap circuit of the diplexer 2 shown in FIG. 8 blocks passage of signals having a frequency in the DCS transmission/reception band, while the third trap circuit 5c blocks passage of signals having a frequency in the W-CDMA transmission/reception band. This prevents the DCS and W-CDMA signals of high-frequency bands from flowing into the first transmission/reception circuit 3.

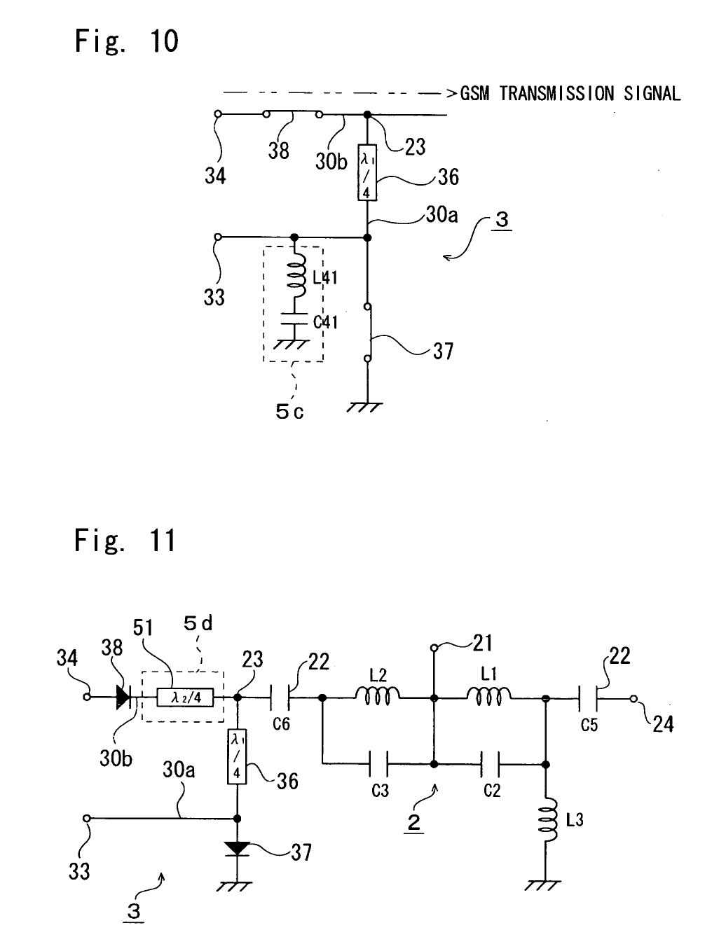

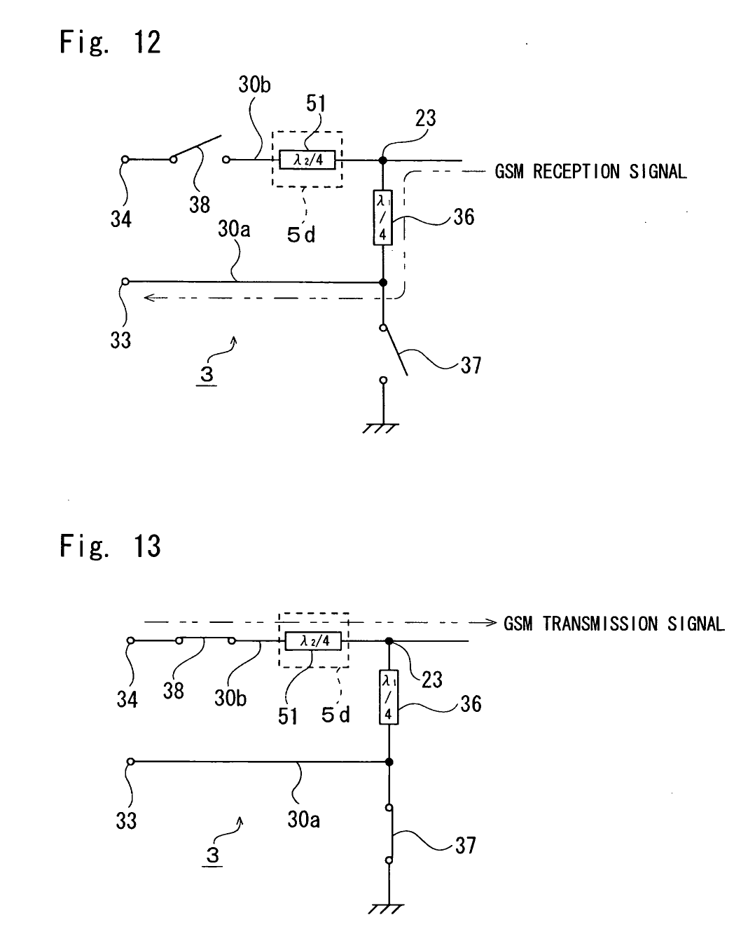

On the other hand, FIG. 10 shows an equivalent circuit of the first transmission/reception circuit 3 of the present embodiment during GSM transmission. The first and second diode switches 37, 38 are set on during GSM transmission. The first diode switch 37 set on causes the microstripline 36 interposed on the reception line 30a to have one end thereof grounded. This causes the microstripline 36 to perform a function of blocking passage of signals of the GSM frequency band. Consequently, GSM transmission signals are prevented from flowing into the reception line 30a from the transmission line 30b.

Therefore, signals of the GSM frequency band hardly pass through the third trap circuit 5c during GSM transmission. Accordingly, the GSM transmission signal loss is reduced.

### Fourth Embodiment

The present embodiment is the same as the above first embodiment except that the third trap circuit has a different configuration. Therefore, only the third trap circuit will be described, and the configuration of other circuits will not be described.

FIG. 11 shows a configuration of the first transmission/reception circuit 3 of the present embodiment, with the low-pass filter circuit 32 shown in FIG. 1 not shown. The second diode switch 38 is interposed in series with the transmission line 30b, while a third trap circuit 5d is interposed between the second diode switch 38 and the branch terminal 23. The third trap circuit 5d includes a microstripline 51 with a length corresponding to one-fourth wavelength of W-CDMA transmission/reception signals.

The microstripline 36 with a length corresponding to one-fourth wavelength of GSM transmission signals is interposed on the reception line 30a. The first diode switch 37 has one end thereof connected to a connection line between the microstripline 36 and the reception signal terminal 33, with the other end grounded.

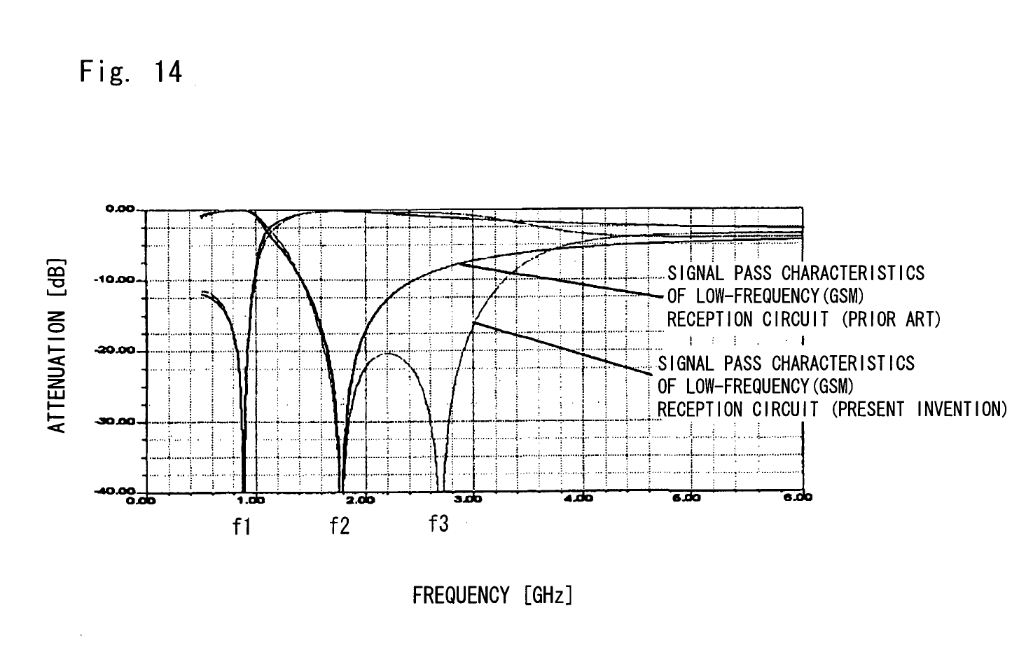

FIG. 12 shows an equivalent circuit of the first transmission/reception circuit 3 during GSM reception. Signals input from the antenna connecting terminal 21 shown in FIG. 11 reach via the first trap circuit in the diplexer 2 to the branch terminal 23. The first trap circuit blocks passage of signals having a frequency in the DCS transmission/reception band, and therefore signals having a frequency outside the DCS transmission/reception band are input to the branch terminal 23.

During GSM reception, as shown in FIG. 12, the first and second diode switches 37, 38 are set off, so that a terminal end of the microstripline 51 of the third trap circuit 5d is open. This causes the microstripline 51 to perform a function of preventing signals having a frequency in the W-CDMA transmission/reception band from passing into the transmission line 30b. Consequently, the third trap circuit 5d prevents the signals having a frequency in the W-CDMA transmission/reception band from flowing into the transmission line 30b. The microstripline 36 is interposed in series with the reception line 30a, and therefore simply functions as a connection line. Consequently, signals having a frequency in the GSM transmission/reception band are output from the reception signal terminal 33.

The first and second diode switches 37, 38 of the first transmission/reception circuit 3 are set off also during DCS and W-CDMA transmission/reception. In this case, the first trap circuit of the diplexer 2 shown in FIG. 11 blocks passage of signals of the DCS transmission/reception band, while the third trap circuit 5d blocks passage of signals of the W-CDMA transmission/reception band. This prevents the DCS and W-CDMA signals of high-frequency bands from flowing into the first transmission/reception circuit 3.

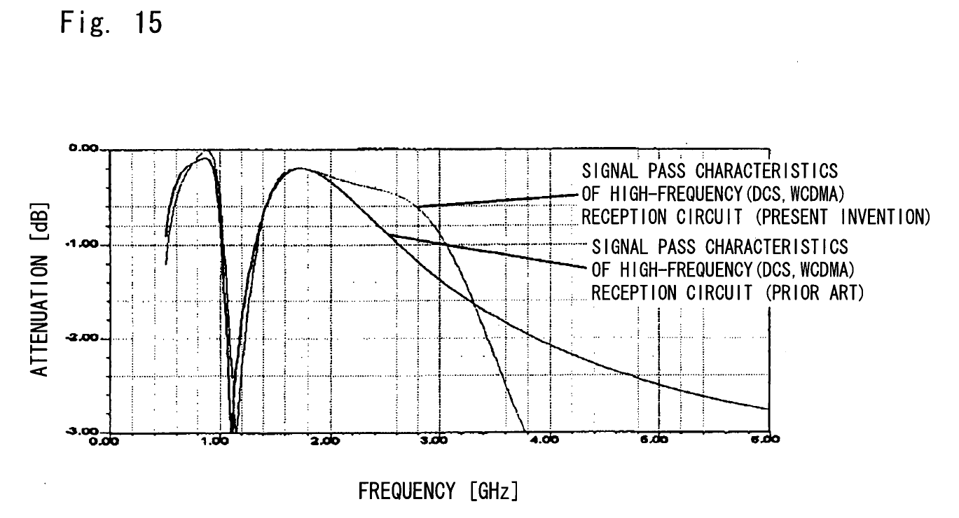

On the other hand, FIG. 13 shows an equivalent circuit of the first transmission/reception circuit 3 during GSM transmission. The first and second diode switches 37, 38 are set on during GSM transmission. The second diode switch 38 set on causes the microstripline 51 constituting the third trap circuit 5d to be connected in series with the transmission line 30b. Consequently, the third trap circuit 5d loses its function as a trap circuit, so that the third trap circuit 5d simply functions as a connection line. The GSM transmission signal loss is reduced because the third trap circuit 5d fails to function as a trap circuit during GSM transmission.

The first diode switch 37 set on causes the microstripline 36 interposed in series with the reception line 30a to have one end thereof grounded. This causes the microstripline 36 to perform a function of blocking passage of signals of the GSM transmission/reception band. Consequently, the signals are prevented from flowing into the reception line 30a from the transmission line 30b.

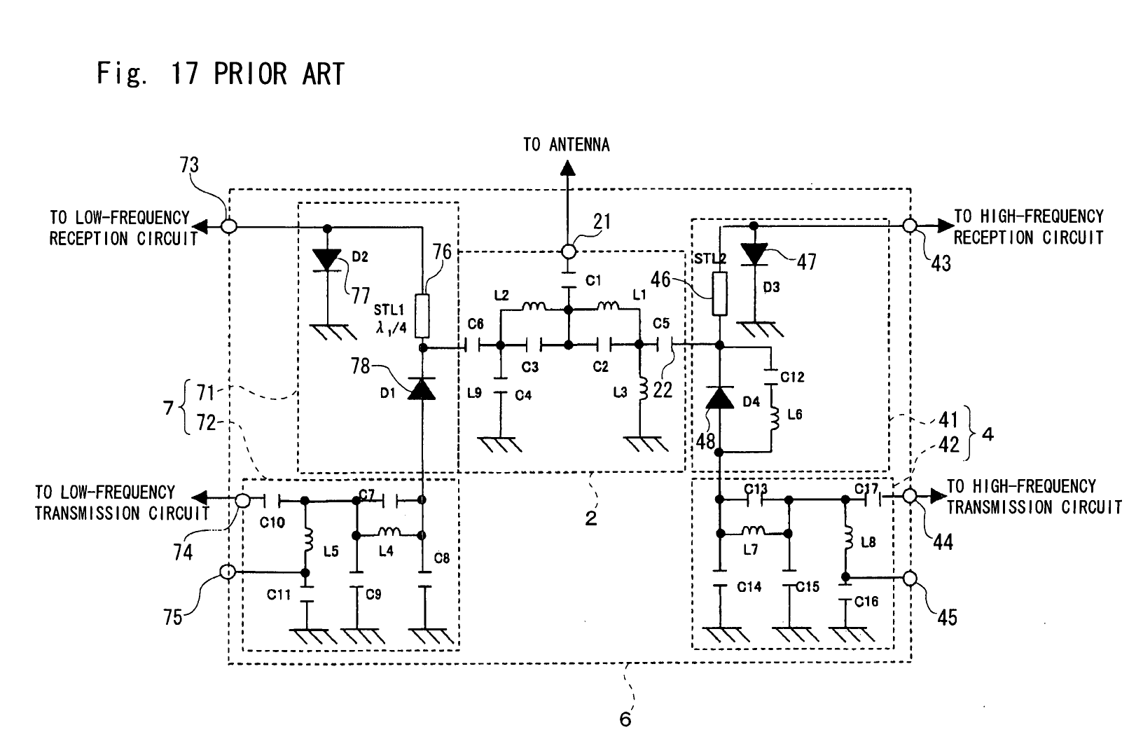

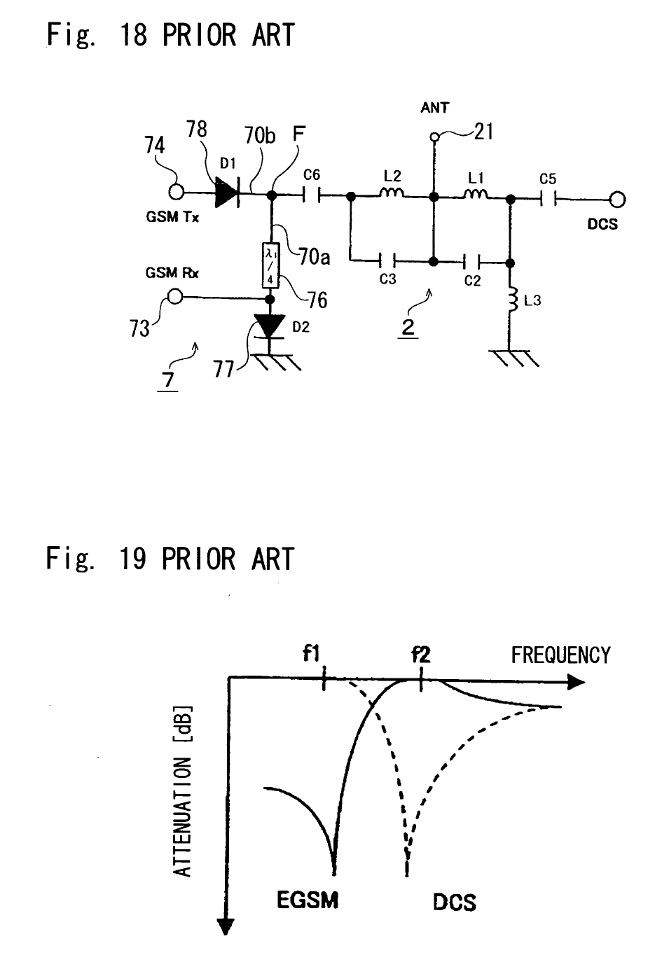

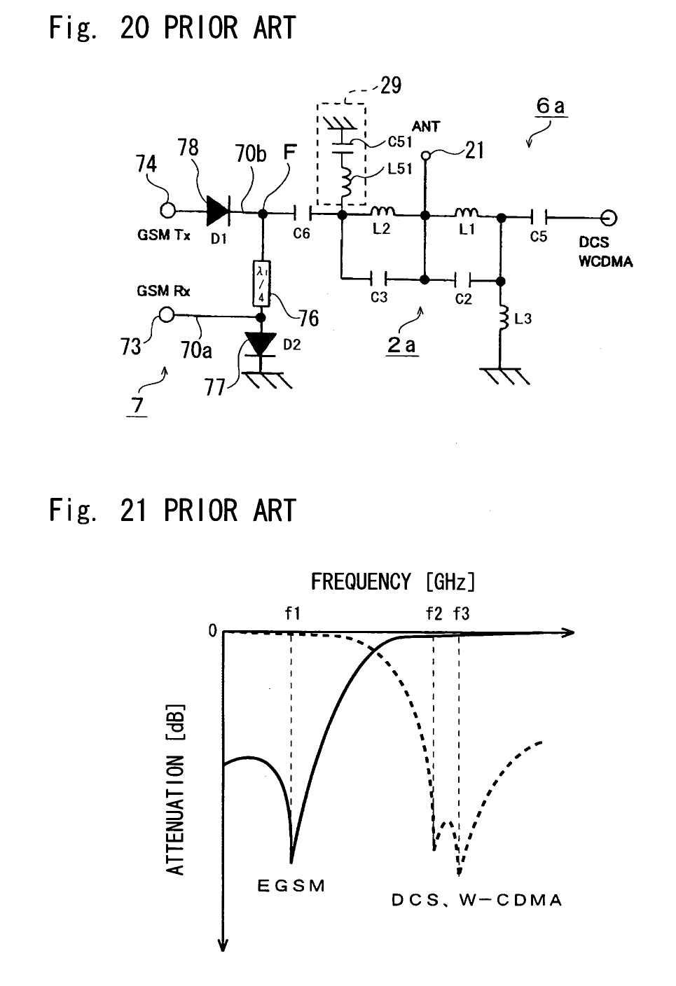

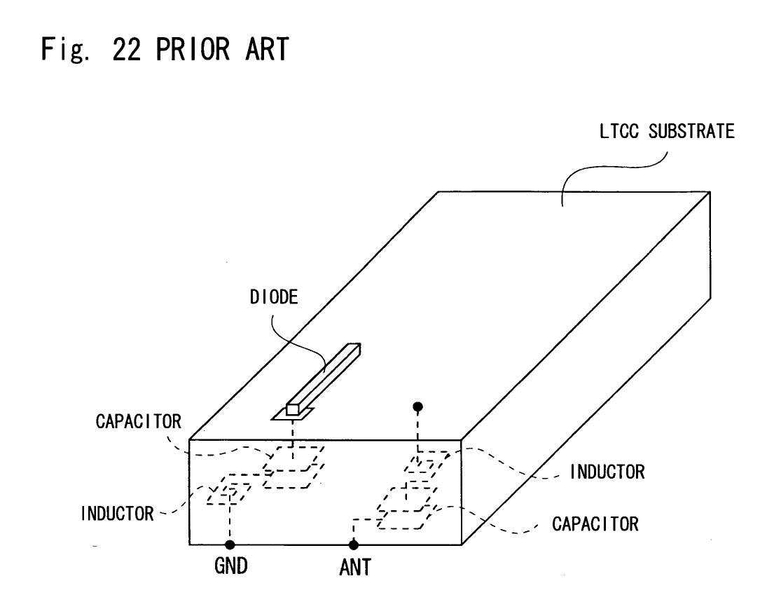

FIG. 14 is a graph showing a simulation result of signal pass characteristics of the antenna duplexer 1 of the first embodiment of the present invention shown in FIG. 1, and signal pass characteristics of the conventional dual band type antenna duplexer 6 shown in FIG. 17. FIG. 15 is a graph enlargingly showing a range of 0 db to −3 db of the ordinate of FIG. 14.

It can be seen that with the antenna duplexer 1 of the first embodiment of the present invention, as shown in FIG. 14, a new attenuation pole is added at a frequency f3 within the W-CDMA transmission/reception band by addition of the third trap circuit 5a shown in FIG. 2 in the first transmission/reception circuit 3. This prevents signals having a frequency in the W-CDMA transmission/reception band from flowing into the first transmission/reception circuit 3 during reception of GSM signals, or during DCS and W-CDMA transmission/reception. Therefore, as shown in FIG. 15, loss in the W-CDMA signal band can be reduced more than conventionally.

On the other hand, because the third trap circuit 5a shown in FIG. 2 loses its function as a trap circuit during transmission of GSM signals, the third trap circuit 5a will not attenuate signals having a frequency in the GSM transmission/reception band. Furthermore, loss of signals having a frequency in the GSM signal transmission/reception band can be reduced by suitably selecting a combination of the inductor L21 and the capacitor C21 of the third trap circuit 5a, while maintaining a constant product of an inductance of the inductor L21 and a capacitance of the capacitor C21.

Therefore, according to the antenna duplexer 1 of the present invention, good transmission/reception performance can be achieved because the third trap circuit can certainly prevent W-CDMA transmission/reception signals from flowing into the first transmission/reception circuit, as well as because GSM transmission signal loss during GSM transmission can be reduced more than conventionally.

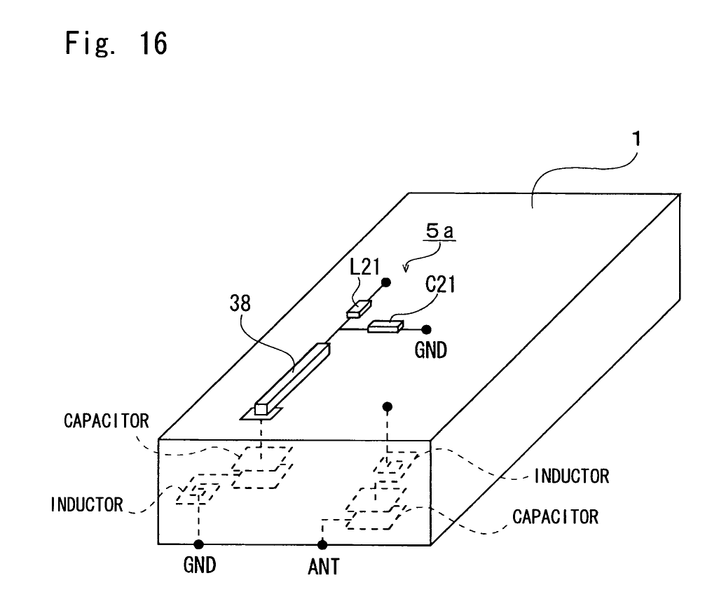

The third trap circuits 5a-5d in the antenna duplexer 1 of the first to fourth embodiments of the present invention are each connected to one end of the first diode switch 37 or second diode switch 38. As shown in FIG. 16, diode switches are generally mounted on a surface of an LTCC substrate. Therefore, triple band capability can be achieved, for example, by only adding the third trap circuit 5a-5c including chip parts, or microstripline 51, on a surface of an LTCC substrate having the conventional dual type antenna duplexer 6 shown in FIG. 17 modularized thereon. Thus, the triple band capability can be achieved by only design change of a ceramic layer constituting a surface layer of the LTCC substrate. Consequently, design and development time for the antenna duplexer 1 can be shortened more than conventionally.

Further, after design change of a ceramic layer constituting a surface layer of the LTCC substrate, signal pass characteristics of the antenna duplexer 1 can be changed by only changing chip parts of the third trap circuit 5a-5d. For example, for the transmission/reception band of PCS instead of W-CDMA, it is possible to suitably select chip parts of the third trap circuit 5a-5c, or to adjust the length of the microstripline 51 of the third trap circuit 5d.

The present invention is not limited to the foregoing embodiments in construction but can be modified variously by one skilled in the art without departing from the spirit of the invention as set forth in the appended claims. For example, the third trap circuit 5b of the above second embodiment, or the third trap circuit 5c of the third embodiment, may be formed outside the antenna duplexer 1, i.e. outside the reception signal terminal 33 shown in FIG. 5 or FIG. 8. Triple band capability can be achieved, for example, by adding the above third trap circuit outside the reception signal terminal 73 of the conventional dual type antenna duplexer 6 shown in FIG. 17. Therefore, time shortening and cost reduction for design/development of the antenna duplexer 1 are possible.

What is claimed is:

1. An antenna duplexer for transmitting/receiving radio waves of a plurality of different frequency bands, the antenna duplexer comprising a first trap circuit for blocking passage of a signal of a first frequency band, disposed between a first terminal 24 and an antenna connecting terminal 21; a second trap circuit for blocking passage of a signal of a second frequency band different from the first frequency band, disposed between a second terminal 23 and the antenna connecting terminal 21; a second transmission/reception circuit 4 connected to the first terminal 24, for transmitting/receiving signals of the second frequency band and a third frequency band adjacent thereto; and a first transmission/reception circuit 3 connected to the second terminal 23, for transmitting/receiving a signal of the first frequency band, the first transmission/reception circuit 3 having a reception line 30a for passing therethrough a reception signal of the first frequency band, and a transmission line 30b for passing therethrough a transmission signal of the first frequency band, the reception line 30a having a microstripline 36 with a length corresponding to one-fourth wavelength of the transmission signal of the first frequency band, interposed in series therewith, and a first diode switch 37 having one end thereof connected to a connection line from the microstripline 36 to a reception signal terminal 33 at a terminal end of the reception line 30a, with the other end grounded, the transmission line 30b having a second diode switch 38 interposed in series therewith, and a third trap circuit 5a for blocking passage of a signal of the third frequency band, interposed between the second diode switch 38 and the second terminal 23, the third trap circuit 5a comprising an inductor and a capacitor, wherein any one passive device of the inductor and the capacitor is interposed between the second diode switch 38 and the second terminal 23, and the other passive device has one end thereof connected to a connection line between the one passive device and the second diode switch 38, with the other end grounded.

2. The antenna duplexer according to claim 1, wherein the antenna duplexer is modularized using a laminated substrate, and the third trap circuit is provided on a surface of the laminated substrate, together with the first diode switch 37 and the second diode switch 38.

3. An antenna duplexer for transmitting/receiving radio waves of a plurality of different frequency bands, the antenna duplexer comprising a first trap circuit for blocking passage of a signal of a first frequency band, disposed between a first terminal 24 and an antenna connecting terminal 21; a second trap circuit for blocking passage of a signal of a second frequency band different from the first frequency band, disposed between a second terminal 23 and the antenna connecting terminal 21; a second transmission/reception circuit 4 connected to the first terminal 24, for transmitting/receiving signals of the second frequency band and a third frequency band adjacent thereto; and a first transmission/reception circuit 3 connected to the second terminal 23, for transmitting/receiving a signal of the first frequency band,
the first transmission/reception circuit 3 having a reception line 30a for passing therethrough a reception signal of the first frequency band, and a transmission line 30b for passing therethrough a transmission signal of the first frequency band, the transmission line 30b having a second diode switch 38 interposed in series therewith, the reception line 30a having a microstripline 36 with a length corresponding to one-fourth wavelength of the transmission signal of the first frequency band, interposed in series therewith; a third trap circuit 5b for blocking passage of a signal of the third frequency band, interposed between the microstripline 36 and a reception signal terminal 33 at a terminal end of the reception line 30a, the third trap circuit 5b comprising an inductor and a capacitor connected in parallel with each other; and a first diode switch 37 having one end thereof connected to a connection line between the third trap circuit 5b and the microstripline 36, with the other end grounded.

4. The antenna duplexer according to claim 3, wherein the antenna duplexer is modularized using a laminated substrate, and the third trap circuit is provided on a surface of the laminated substrate, together with the first diode switch 37 and the second diode switch 38.

5. An antenna duplexer for transmitting/receiving radio waves of a plurality of different frequency bands, the antenna duplexer comprising a first trap circuit for blocking passage of a signal of a first frequency band, disposed between a first terminal 24 and an antenna connecting terminal 21; a second trap circuit for blocking passage of a signal of a second frequency band different from the first frequency band, disposed between a second terminal 23 and the antenna connecting terminal 21; a second transmission/reception circuit 4 connected to the first terminal 24, for transmitting/receiving signals of the second frequency band and a third frequency band adjacent thereto; and a first transmission/reception circuit 3 connected to the second terminal 23, for transmitting/receiving a signal of the first frequency band,
the first transmission/reception circuit 3 having a reception line 30a for passing therethrough a reception signal of the first frequency band, and a transmission line 30b for passing therethrough a transmission signal of the first frequency band, the transmission line 30b having a second diode switch 38 interposed in series therewith, the reception line 30a having a microstripline 36 with a length corresponding to one-fourth wavelength of the transmission signal of the first frequency band, interposed in series therewith; a third trap circuit 5c for blocking passage of a signal of the third frequency band, connected to a connection line from the microstripline 36 to a reception signal terminal 33 at a terminal end of the reception line 30a, the third trap circuit 5c comprising an inductor and a capacitor connected in series with each other, the third trap circuit 5c having one end thereof connected to the connection line from the microstripline 36 to the reception signal terminal 33 at the terminal end of the reception line 30a, with the other end grounded; and a first diode switch 37 having one end thereof connected to a connection line between the third trap circuit 5c and the microstripline 36, with the other end grounded.

6. The antenna duplexer according to claim 5, wherein the antenna duplexer is modularized using a laminated substrate, and the third trap circuit is provided on a surface of the laminated substrate, together with the first diode switch 37 and the second diode switch 38.

7. An antenna duplexer for transmitting/receiving radio waves of a plurality of different frequency bands, the antenna duplexer comprising a first trap circuit for blocking passage of a signal of a first frequency band, disposed between a first terminal 24 and an antenna connecting terminal 21; a second trap circuit for blocking passage of a signal of a second frequency band different from the first frequency band, disposed between a second terminal 23 and the antenna connecting terminal 21; a second transmission/reception circuit 4 connected to the first terminal 24, for transmitting/receiving signals of the second frequency band and a third frequency band adjacent thereto; and a first transmission/reception circuit 3 connected to the second terminal 23, for transmitting/receiving a signal of the first frequency band,
the first transmission/reception circuit 3 having a reception line 30a for passing therethrough a reception signal of the first frequency band, and a transmission line 30b for passing therethrough a transmission signal of the first frequency band, the reception line 30a having a microstripline 36 with a length corresponding to one-fourth wavelength of the transmission signal of the first frequency band, interposed in series therewith, and a first diode switch 37 having one end thereof connected to a connection line from the microstripline 36 to a reception signal terminal 33 at a terminal end of the reception line 30a, with the other end grounded, the transmission line 30b having a second diode switch 38 interposed in series therewith, and a microstripline 51 with a length corresponding to one-fourth wavelength of a signal of the third frequency band, interposed between the second diode switch 38 and the second terminal 23, the microstripline 51 constituting a third trap circuit 5d for blocking passage of the signal of the third frequency band.

8. The antenna duplexer according to claim 7, wherein the antenna duplexer is modularized using a laminated substrate, and the third trap circuit is provided on a surface of the laminated substrate, together with the first diode switch 37 and the second diode switch 38.
